(19) United States
(12) Patent Application Publication
(10) Pub. No.: US 2026/0280714 A1
(43) Pub. Date: Sep. 17, 2026

(54) POLARIZATION BASED DUAL-MODE OPTICAL TRANSCEIVER

(71) Applicant: Lumos Infinitas USA Inc., Irvine, CA (US)

(72) Inventors: Babak BAHARI, Irvine, CA (US); Dachuan WU, Aliso Viejo, CA (US); Dawei ZHENG, Irvine, CA (US)

(73) Assignee: Lumos Infinitas USA Inc., Irvine, CA (US)

(21) Appl. No.: 19/080,699

(22) Filed: Mar. 14, 2025

(51) Int. Cl. H04B 10/40; H04B 10/61; H04B 10/80

(52) U.S. Cl. CPC H04B 10/40; H04B 10/614; H04B 10/6151; H04B 10/802

(57) ABSTRACT

An optical sensor that employs either a polarization-dependent or a polarization-independent transceiver, where the transceiver receives a portion of an input light signal of a linear polarization mode (e.g. TE mode), and transmits into space, toward a target, a light signal of that linear polarization modes. The transceiver receives a back-scattered light from the target that contains both the linear polarization mode of the input light (e.g. TE mode) and an orthogonal linear polarization mode (e.g. TM mode). The orthogonal linear polarization mode of the back-scattered signal is sent to a photonic mixer to be mixed with another portion of the input light signal to generate a mixed signal for detection. No polarization-altering elements is present between the transceiver and the target to convert the linear polarizations to circular polarizations.

### BACKGROUND OF THE INVENTION

This invention relates to optical sensors, and in particular, it relates to optical sensors that that employ either a polarization-dependent or a polarization-independent transceiver.

The field of optical transceivers has seen significant advancements, particularly in dual-mode operation for managing orthogonal polarizations, such as transverse electric (TE) and transverse magnetic (TM) modes. However, conventional optical transceivers often suffer from crosstalk between transmitted and received signals, leading to degraded system performance. Furthermore, achieving efficient polarization management while ensuring scalability to arrays for advanced applications, such as point cloud generation, remains a challenge.

U.S. Pat. Appl. Pub. No. 2024/0195077 describes an integrated photonic platform for a transceiver aperture (see Abstract). The transceiver aperture includes an array of pixels, each of the pixels comprising a photonic radiator comprising one or more ports; a photonic mixer comprising an Rx input and a local oscillator (LO) input; and an optical mixer comprising a Tx input; an input/output port; a first output; and a second output, wherein the input/output port is coupled to the one or more ports of the photonic radiator and the first output is coupled to the Rx input (see Claim 1).

### SUMMARY OF THE INVENTION

There exists a need for improved polarization-dependent and polarization-independent optical transceivers capable of minimizing crosstalk, managing polarization efficiently, and being combined into scalable arrays. These advancements are critical for applications such as optical communication systems, sensing, and imaging where precise signal transmission and reception are essential.

The present invention is directed to dual-mode optical transceivers and related methods that substantially obviates one or more of the problems due to limitations and disadvantages of the related art.

Embodiments of the present invention provide dual-mode optical transceivers capable of operating with orthogonal polarizations (TE and TM modes) to achieve transmission and reception with minimal crosstalk. The embodiments include both polarization-dependent and polarization-independent transceivers, incorporating photonic mixers and polarization beam splitters for efficient signal management. Embodiments of the present invention further enable scalable arrays of such transceivers using optical power splitters, such as optical switch trees, for applications like point cloud generation, ensuring efficient, accurate, and high-performance optical systems.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve the above objects, the present invention provides an optical sensor, which includes: an optical transceiver, including a radiation area and an input port and an output port coupled to the radiation area, wherein the radiation area is configured to radiate into space a light signal of a first polarization mode and to receive from the space a light signal containing both the first polarization mode and a second polarization mode, the first and second polarization modes being two perpendicular linear polarization modes including a transverse electric (TE) mode and a transverse magnetic (TM) mode; an optical lens configured to direct the radiated light signal from the optical transceiver toward a target and to direct a back-reflected light from the target to the optical transceiver, wherein the optical sensor is free of any polarization altering optical component between the optical transceiver and the optical lens; and a photonic mixer configured to mix the received light signal with a reference local oscillator signal.

In some embodiments, the optical sensor further includes: a laser configured to generate a coherent light signal; and a power beam splitter configured to direct a portion of the light signal from the laser to the photonic mixer as the local oscillator signal, and to direct another portion of the light signal from the laser to the input port of the optical transceiver; wherein the input port and the output port of the optical transceiver are two separate ports which are mode matched to respectively pass only the first polarization mode and the second polarization mode, and wherein the optical transceiver is configured to pass the second polarization mode of the received light signal via the output port to the photonic mixer.

In some embodiments, the optical sensor further includes: a laser configured to generate a coherent light signal; a power beam splitter configured to direct a portion of the light signal from the laser to the photonic mixer as the local oscillator signal; and a polarization beam splitter and rotator having a first port, a second port, and a third port respectively coupled to the power beam splitter, the photonic mixer, and the optical transceiver, wherein the power beam splitter is further configured to direct another portion of the light signal from the laser to the first port of the polarization beam splitter and rotator, wherein the polarization beam splitter and rotator is configured to pass only the first polarization mode of the other portion of the light signal from the first port to the third port, wherein the input port and the output port of the optical transceiver are a common port coupled to the third port of the polarization beam splitter and rotator and configured passes both the first and the second polarization modes, wherein the optical transceiver is configured to radiate the first polarization mode of the other portion of the light signal from the polarization beam splitter and rotator, and to pass both the first polarization mode and the second polarization mode of the received light signal via the common port to the third port of the polarization beam splitter and rotator, and wherein the polarization beam splitter and rotator is further configured to convert the second polarization mode of the received light signal from the optical transceiver to the first polarization mode and direct the converted light signal to its second port for coupling to the photonic mixer.

In another aspect, the present invention provides an array of optical sensors, which includes: a plurality of the optical sensors described above; a laser configured to generate a coherent light signal; and an optical power splitter and switch tree structure configured to split the coherent light signal of the laser among the plurality of the optical sensors.

In some embodiments, the optical power splitter and switch tree structure includes one or more components selected from a group consisting of: Mach-Zehnder modulators, thermal modulators, and PIN modulators.

In some embodiments, the optical power splitter and switch tree structure is configured to supply light signals to the plurality of the optical sensors simultaneously.

In some embodiments, the optical power splitter and switch tree structure is configured to supply light signals to the plurality of the optical sensors at different times.

In some embodiments, each of the plurality of optical sensors further includes a power beam splitter configured to direct a portion of the light signal from the optical power splitter and switch tree structure to the photonic mixer as the local oscillator signal, and to direct another portion of the light signal from the optical power splitter and switch tree structure to the input port of the optical transceiver; wherein the input port and the output port of the optical transceiver are two separate ports which are mode matched to respectively pass only the first polarization mode and the second polarization mode, and wherein the optical transceiver is configured to pass the second polarization mode of the received light signal via the output port to the photonic mixer.

In some embodiments, each of the plurality of optical sensors further includes: a power beam splitter configured to direct a portion of the light signal from the optical power splitter and switch tree structure to the photonic mixer as the local oscillator signal, a polarization beam splitter and rotator having a first port, a second port, and a third port respectively coupled to the power beam splitter, the photonic mixer, and the optical transceiver, wherein the power beam splitter is further configured to direct another portion of the light signal from the optical power splitter and switch tree structure to the first port of the polarization beam splitter and rotator, wherein the polarization beam splitter and rotator is configured to pass only the first polarization mode of the other portion of the light signal from the first port to the third port, wherein the input port and the output port of the optical transceiver are a common port coupled to the third port of the polarization beam splitter and rotator and configured passes both the first and the second polarization modes, wherein the optical transceiver is configured to radiate the first polarization mode of the other portion of the light signal from the polarization beam splitter and rotator, and to pass both the first polarization mode and the second polarization mode of the received light signal via the common port to the third port of the polarization beam splitter and rotator, and wherein the polarization beam splitter and rotator is further configured to convert the second polarization mode of the received light signal from the optical transceiver to the first polarization mode and direct the converted light signal to its second port for coupling to the photonic mixer.

In another aspect, the present invention provides a method for transmitting an optical signal and detecting a back-reflected optical signal using an optical sensor, which includes: generating a coherent light signal; splitting the light signal using a power beam splitter and directing a portion of the light signal to a photonic mixer as a local oscillator signal, and directing another portion of the light signal to an input port of an optical transceiver; passing only a first polarization mode of the other portion of the light signal through the input port of the optical transceiver to a radiation area of the optical transceiver, and radiating the first polarization mode into space as a radiated light signal; directing the radiated light signal from the optical transceiver toward a target and directing a back-reflected light from the target to the optical transceiver, without altering polarization modes of the radiated light signal and the back-reflected light signal, wherein the back-reflected light signal contains both the first polarization mode and a second polarization mode, wherein the first and second polarization modes are two perpendicular linear polarization modes including a transverse electric (TE) mode and a transverse magnetic (TM) mode; capturing the back-reflected light signal by the radiation area of the optical transceiver, including both the first polarization mode and a second polarization mode; coupling only the second polarization mode of the captured light signal to an output port of the optical transceiver; directing the light signal from the output port of the optical transceiver into the photonic mixer; and coherently mixing the local oscillator signal and the received signals from the optical transceiver in the photonic mixer to generate In-phase and Quadrature-phase (IQ) signals.

In another aspect, the present invention provides a method for transmitting optical signals and detecting a back-reflected optical signals using a plurality of optical sensors, which includes: performing the method described above by each of the plurality of optical sensors, wherein the step of generating the coherent light signal includes: generating a coherent input light using a laser; and splitting the coherent input light of the laser among the plurality of the optical sensors using an optical power splitter and switch tree structure, to supply the coherent light signals, wherein coherent light signals are either supplied to the plurality of the optical sensors simultaneously, or supplied to the plurality of the optical sensors at different times.

In another aspect, the present invention provides a method for transmitting an optical signal and detecting a back-reflected optical signal using an optical sensor, which includes: generating a coherent light signal; splitting the light signal using a power beam splitter and directing a portion of the light signal to a photonic mixer as a local oscillator signal, and directing another portion of the light signal to a first port of a polarization beam splitter and rotator; the polarization beam splitter and rotator passing only the first polarization mode of the other portion of the light signal from the first port to a third port of the polarization beam splitter and rotator; an optical transceiver receiving the first polarization mode of the other portion of the light signal from the third port of the polarization beam splitter and rotator, and radiating the first polarization mode into space as a radiated light signal; directing the radiated light signal from the optical transceiver toward a target and directing a back-reflected light from the target to the optical transceiver, without altering polarization modes of the radiated light signal and the back-reflected light signal, wherein the back-reflected light signal contains both the first polarization mode and a second polarization mode, wherein the first and second polarization modes are two linear perpendicular polarization modes including a transverse electric (TE) mode and a transverse magnetic (TM) mode; capturing the back-reflected light signal by the radiation area of the optical transceiver, including both the first polarization mode and a second polarization mode; directing the captured light including both the first and the second polarization modes form the optical transceiver to the third port of the polarization beam splitter and rotator; the polarization beam splitter and rotator converting the second polarization mode of the received light signal on its third port to the first polarization mode and directing the converted light signal via its second port to the photonic mixer; and coherently mixing the local oscillator signal and the received signals from the optical transceiver in the photonic mixer to generate In-phase and Quadrature-phase (IQ) signals.

In another aspect, the present invention provides a method for transmitting optical signals and detecting a back-reflected optical signals using a plurality of optical sensors, which includes: performing the method described above by each of the plurality of optical sensors, wherein the step of generating the coherent light signal includes: generating a coherent input light using a laser; and splitting the coherent input light of the laser among the plurality of the optical sensors using an optical power splitter and switch tree structure, to supply the coherent light signals, wherein coherent light signals are either supplied to the plurality of the optical sensors simultaneously, or supplied to the plurality of the optical sensors at different times.

It is to be understood that both the foregoing general description and the following detailed description are exemplary and explanatory and are intended to provide further explanation of the invention as claimed.

### BRIEF DESCRIPTION OF DRAWINGS

FIG. 1 schematically illustrates light scattering from a target which generates multiple polarizations in the scattered light.

FIG. 2 schematically illustrates a coherent optical sensor employing a polarization-dependent transceiver according to an embodiment of the present invention.

FIG. 3 schematically illustrates a coherent optical sensor employing a polarization-independent transceiver according to another embodiment of the present invention.

FIGS. 4A, 4B and 4C schematically illustrate different types of polarization dependent and independent transceivers that may be used to implement embodiments of the present invention. FIG. 4A illustrates a 2D grating coupler which may be used as a polarization-dependent transceiver. FIG. 4B illustrates a 1D grating coupler which may be used as a polarization-independent transceiver. FIG. 4C illustrates an edge coupler waveguide made from Si or SiN which may be used as a polarization-independent transceiver.

FIG. 5 schematically illustrates a coherent optical sensor array formed of multiple distinct single element sensors each employing a polarization-dependent transceiver according to another embodiment of the present invention.

FIG. 6 schematically illustrates a coherent optical sensor array formed of multiple distinct single element sensors each employing a polarization-independent transceiver according to another embodiment of the present invention.

### DETAILED DESCRIPTION OF THE INVENTION

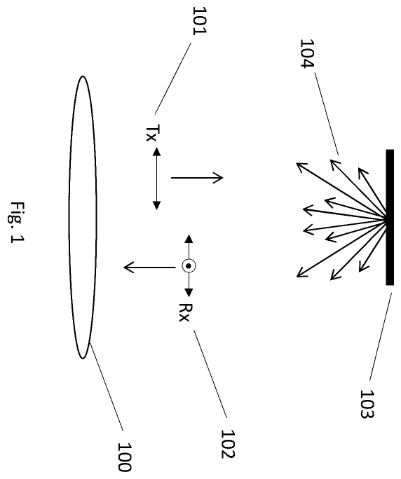

Generally, as illustrated in FIG. 1, when a linearly polarized light 101 shines on a target 103, the back-reflected light 104 (102) from the target experiences a light scattering that affects its amplitude and polarization. In terms of the amplitude, a part of the power is absorbed by the target due to material loss, a part of it passes through the target, and the rest is backscattered. The scattered light 104 has, in general, a Lambertian profile. The polarization status of the back-reflected light 102 is changed such that it experiences a polarization conversion, and other possible polarizations (different from that of the incident light) can be generated. Therefore, for an optical sensor (an optical lens 100 of the optical sensor is schematically shown in FIG. 1), if the transmitted light (Tx) 101 (i.e. the incident light on the target) is a TE polarized light, the back-reflected light (Rx) 102 from the target will have both TE and TM polarizations.

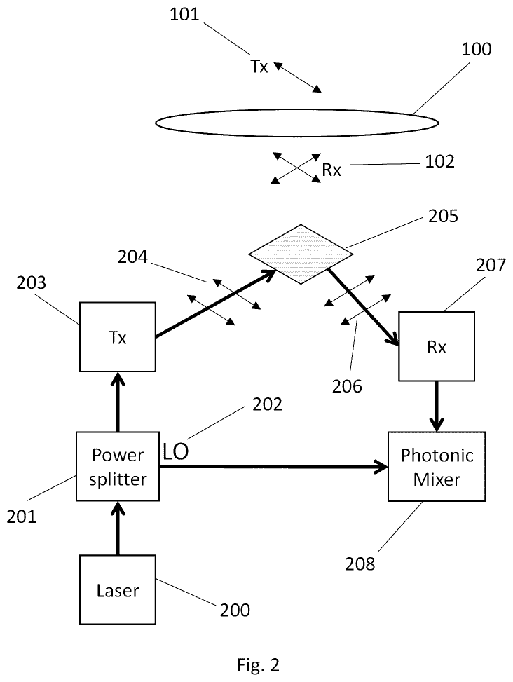

FIG. 2 schematically illustrates a coherent optical sensor that employs a polarization-dependent optical transceiver according to a first embodiment of the present invention. The input light from a laser source 200 is a coherent light that contains only the TE mode (if the light originally contains both polarization modes, the TM mode will be filtered out). The input light is split by a power beam splitter 201 into two parts. A smaller part, LO signal 202, is for a local oscillator (LO) and is directed to a photonic mixer 208 to be mixed with the received signal. A larger part 204 is directed into a transmitting path Tx 203 for radiation to the space through the transceiver.

The optical transceiver 205 is a polarization-dependent element having two ports which are respectively polarization matched to the two linear polarization modes, i.e., they only pass the matched polarization modes. One port (input port or Tx port) of the transceiver 205 is coupled to the transmitting path Tx 203 to pass the optical signal 204 to be transmitted, and the other port (output port or Rx port) is coupled to a receiving path Rx 207 for transmitting back-reflected optical signals received by the transceiver. Both ports work with a fundamental waveguide mode, i.e., TE polarization. It should be noted that due to the construction of the transceiver 205 (e.g., a 2D grating described in more detail later), a linear polarization that is TE mode from the standpoint of one port is TM mode from the standpoint of the other port and vice versa. The radiation area of the transceiver 205 radiates the signal 204 from the Tx port to the space.

FIG. 2 also schematically illustrates the optical lens 100 of the coherent optical sensor, the transmitted light signal Tx 101, and the back-reflected light signal Rx 102 from the target. The radiation area of the transceiver 205 receives (captures) the back-reflected light signal. The transmitter and receiver are the same device (the transceiver 205), thus the transmitted signal and the received signal travel the same optical path between the target and the transceiver. No quarter wave plate or other polarization altering optical component is used in the optical sensor to change the polarization state of the transmitted and received light between the transceiver 205 and the target. The light transmitted from the lens 100 to the target is the linearly polarized light (e.g. TE from the standpoint of the Tx port) emitted by the transceiver 205. Due to scattering effects and polarization conversion by the target, the back-reflected light signal Rx 102 contains both linearly polarized components, i.e., both the same polarization as the transmitted signal (referred to as the unrotated polarization mode) and the orthogonal polarization (referred to as the rotated polarization mode). The unrotated mode of the back-reflected light received by the radiation area of the transceiver 205, which is TE mode from the standpoint of the Tx port, is back-coupled by the polarization-dependent transceiver 205 into the Tx path 203, which will pass through the beam splitter 201 and be absorbed by an optical isolator inside the laser 200. The rotated mode of the light received by the transceiver 205, which is TM mode from the standpoint of the Tx port but is TE mode from the standpoint of the Rx port, is polarization matched with the Rx port, so it is coupled by the transceiver 205 to that port (as signal 206) and directed along Rx path 207 to the photonic mixer 208. The optical paths 203 and 207 may be optical waveguides or free space optical paths, or combinations thereof.

The polarization-dependent transceiver 205 ensures that there is no crosstalk between the transmitted and received signals.

The LO signal 202 and the back-reflected signal 206 from the Rx path 207 are mixed coherently in the photonic mixer 208 to generate a mixed signal for detection. The photonic mixer 208 may include a 90-degree hybrid and two balanced photodetectors (BPD), which are for generating In-phase (I) and Quadrature-phase (Q) signals. Photonic mixers are generally known in the art and can be implemented by any suitable structures.

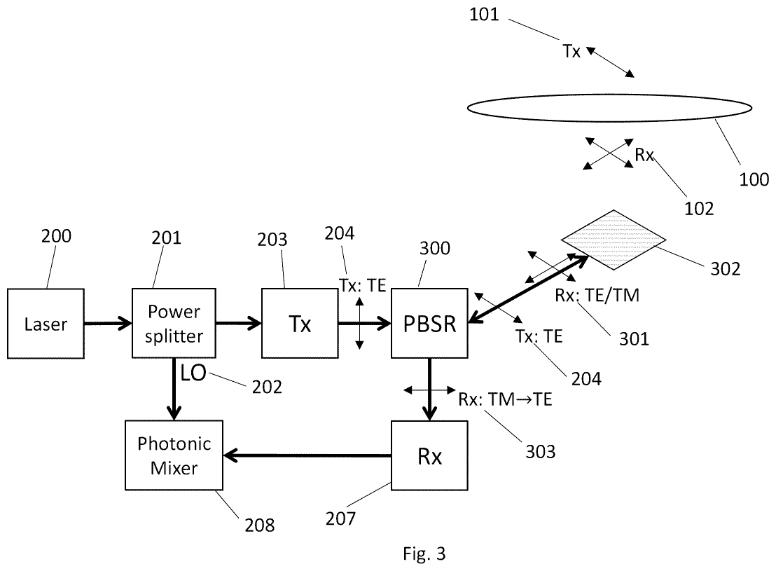

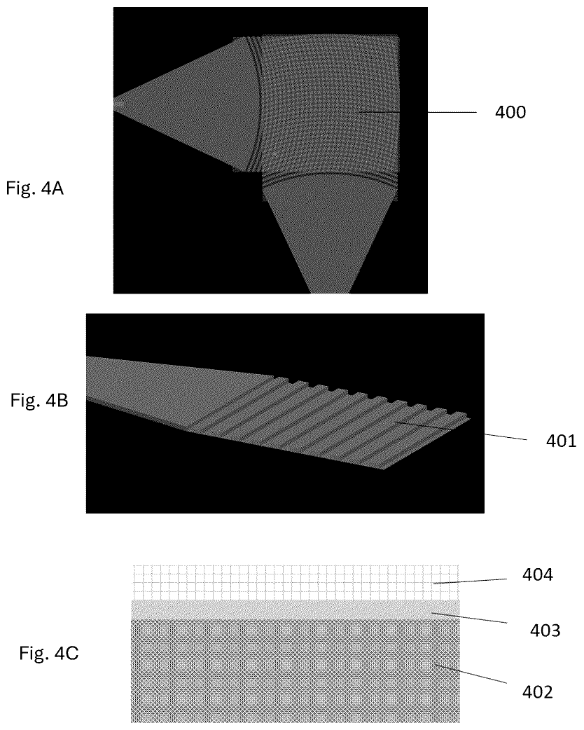

Compared to the structure shown in FIGS. 4a and 4b of US 2024/0195077 (“the ‘077 publication”), which uses a dual channel transceiver 406 (see FIG. 4a), it can be seen that the structure in the ‘077 publication requires a quarter wave plate QWP 404 between the transceiver 406 and the lens 402 to change the polarization of the outgoing and returning beams, whereas in the embodiment shown in FIG. 3 of the present invention, no quarter wave plate or other polarization altering optical component is required. The structure in the ‘077 publication relies on the target's ability to convert between two circular polarized lights (e.g. LHCP (left-hand circular polarized) to RHCP (left-hand circular polarized) light) due to the reflection and polarization rotation (see FIG. 4b). The embodiment of the present invention shown in FIG. 3, however, relies on the target's ability to scatter the light and generate both linearly polarized lights (TM and TE). The device of FIG. 4 of the ‘077 publication does not contemplate utilizing the target's ability to scatter the light and generate both linearly polarized lights for the detection system.

FIG. 3 schematically illustrates a coherent optical sensor that employs a polarization-independent optical transceiver according to another embodiment of the present invention. Similar to the embodiment of FIG. 2, a power beam splitter 201 splits the coherent input light (TE mode) form the laser source 200 into a LO signal 202 and a Tx signal 204 for the transmitting path Tx 203. Different from the embodiment of FIG. 2, here, a polarization beam splitter and rotator (PBSR) 300 with at least three ports (e.g., two input ports and one output port) is provided, which can convert (rotate) between TE and TM polarizations and direct them along separate optical paths. One port (e.g., a first input port) of the PBSR 300 is coupled to the transmitting path Tx 203, another port (e.g., the second input port) is coupled to the receiving path 207, and the third port (e.g., the output port) is coupled to the optical transceiver 302. In this embodiment, the transceiver 302 is a polarization-independent element with one port which is coupled to the output port of the PBSR 300, where the port can pass both polarization mode signals.

The Tx signal 204 (TE mode) on the Tx path 203 passes through the PBSR 300 from its first input port to its output port to enter the transceiver 302, which then radiates the signal to the space. Again, no quarter wave plate or other polarization altering optical component is used in the optical sensor to change the polarization state of the transmitted and received light between the transceiver 302 and the target. Due to scattering effects and polarization conversion by the target, the back-reflected light Rx 102 contains both TE and TM mode components. The received signal Rx 301 output by the polarization-independent transceiver 302 correspondingly contains both TE and TM mode components. In this embodiment, the input port and the output port of the transceiver 302 are the same port, which can pass both TE and TM polarization modes in both directions. This port is coupled to the output port of the PBSR 300 to transmit the receive signal Rx 301 to the PBSR. The received signal Rx 301 is split by the PBSR into two parts. The TE mode of the received signal Rx 301 passes through the PBSR 300 from its output port to its first input port and travels back in the Tx path 204. The TM mode of the received signal Rx 301 is converted into TE mode 303 by the PBSR 300 and directed via its second input port into the receiving path Rx 207. The LO signal 202 and the Rx signals 303 from the PBSR 300 (both TE) are mixed coherently in the photonic mixer 208 to generate a mixed signal for detection.

The PBSR in this embodiment facilitates efficient polarization management to ensure minimal signal loss and no crosstalk between the TE and TM modes.

Compared to the structure shown in FIG. 2b of the ‘077 publication, which uses a single channel photonic transceiver (photonic radiator) 204, the structure in the ‘077 publication does not use a PBS or a QWP for operations (see the ‘077 publication, paragraph [0022]; note that the optical mixer 210 shown in FIGS. 2a and 2b is not a PBSR), whereas in the embodiment shown in FIG. 2 of the present invention, a PBSR is used in conjunction with a single channel transceiver 302. Neither embodiment (FIG. 2 and FIG. 4) of the ‘077 publication contemplates utilizing the target's ability to convert between two linearly polarized lights for the detection system.

In the above embodiments, the polarization-dependent transceiver 205 and the polarization-independent transceiver 302 may be implemented by various structures, as schematically illustrated in FIGS. 4A, 4B and 4C. FIG. 4A illustrates a 2D grating coupler 400 which may be used as a polarization-dependent transceiver. One polarization light (e.g., TE) from one port can be radiated through the grating in a normal direction. The 90-degree rotated polarization light can be coupled into the other port because it is polarization matched with that port. FIG. 4B illustrates a 1D grating coupler 401 which may be used as a polarization-independent transceiver. This grating can be designed to have a similar and large coupling efficiency for both TE and TM polarizations. FIG. 4C illustrates an edge coupler waveguide made from Si or SiN which may be used as a polarization-independent transceiver. The structure includes a Si substrate 402, a waveguiding layer 404 which may be either Si or Si3N4 or any other suitable material that guides optical light, and a SiO2 spacing layer 403 located between the substrate 402 and the waveguiding layer 404. The edge coupler can be designed so that the coupling efficiency for both TE and TM polarizations can be similar and large. These transceivers are known devices and can be implemented by those of ordinary skill in the relevant art. Other suitable devices may also be used to implement the transceivers.

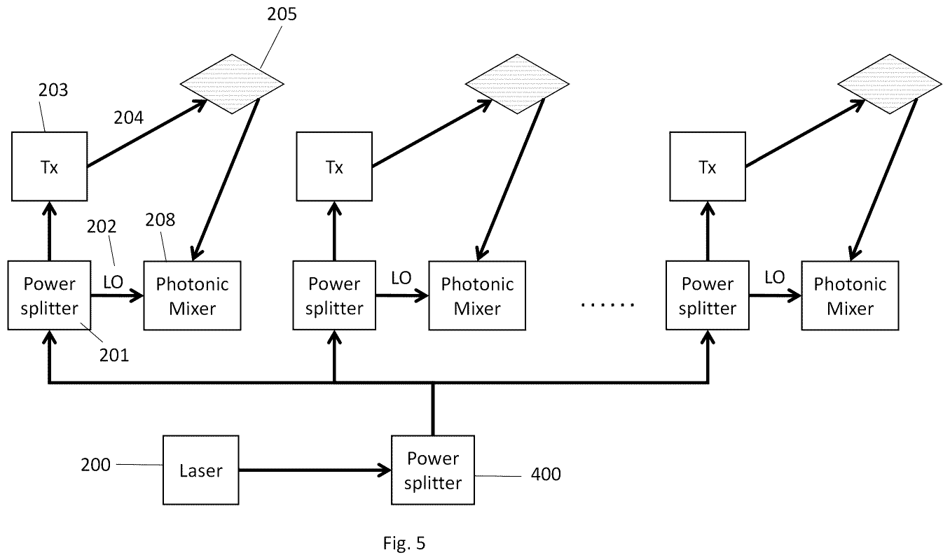

FIG. 5 schematically illustrates a coherent optical sensor array formed of multiple distinct single element sensors each employing a polarization-dependent transceiver according to another embodiment of the present invention. Each sensor is similar to that shown in the embodiment in FIG. 2, and includes a polarization-dependent transceiver 205, a photonic mixer 208, and a power beam splitter 201 that splits the input light into a LO signal 202 directed to the photonic mixer 208 and a Tx signal 204 directed to the transmitting path Tx 203 of the transceiver 205. The light from the laser source 200 is split by an optical power splitter and switch tree structure 500 into multiple paths that respectively provide input light to the multiple sensors. The optical power splitter and switch tree 500 can either split the power (e.g., equally) among the multiple optical sensors and supply them simultaneously, or direct the light into different optical sensors at different times, including supplying a subset of the multiple optical sensors simultaneously and supplying different subsets at different times. The optical power splitter and switch tree can be implemented by thermal modulators, PIN modulators, Mach-Zehnder modulator, a combination of the above, etc. Optical switch trees are generally known in the relevant art.

The multiple polarization-dependent transceivers 205 may be arranged to form an array of multiple transceiver pixels. A common lens (not shown in FIG. 5) is provided for the sensor array. The array can help to increase the field of view (FOV) of the sensor array compared to a single element device. The sensor array can also be used to steer the emitted light in space. When each of the elements is turned on, the light from that transceiver hits a different area on the lens of the sensor array, which causes that light to be bent and transmitted to a specific direction in space. Therefore, each transceiver sends light to a different direction in space.

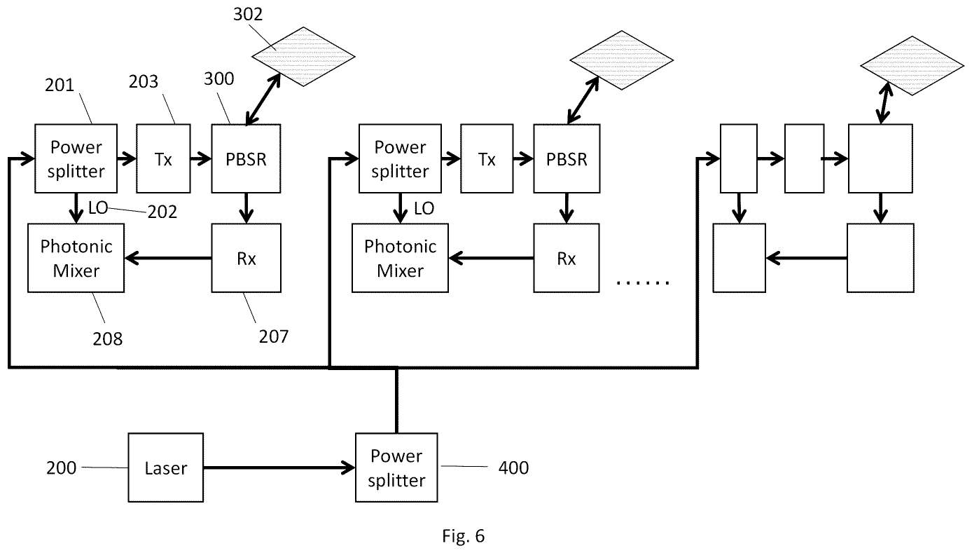

FIG. 6 schematically illustrates a coherent optical sensor array formed of multiple distinct single element sensors each employing a polarization-independent transceiver according to another embodiment of the present invention. Each sensor is similar to that shown in the embodiment in FIG. 3, and includes a polarization-independent transceiver 302, a PBSR 300 coupled to the transceiver 302 as well as to the transmitting path Tx 203 and the receiving path Rx 207, a photonic mixer 208, and a power beam splitter 201 that splits the input light into a LO signal 202 directed to the photonic mixer 208 and a Tx signal directed to the transmitting path Tx 203. Other aspects of the embodiment of FIG. 6 are similar to those of the embodiment of FIG. 5.

The optical sensor arrays described above and shown in FIGS. 5 and 6 may be used to form a system for generating a point cloud. The optical sensor array generates a point cloud by leveraging the dual-mode operation of the transceivers to capture signals in both TE and TM polarizations.

It will be apparent to those skilled in the art that various modification and variations can be made in the optical transceivers, optical sensors and sensor arrays of the present invention without departing from the spirit or scope of the invention. Thus, it is intended that the present invention cover modifications and variations that come within the scope of the appended claims and their equivalents.

1. An optical sensor, comprising:
an optical transceiver, including a radiation area and an input port and an output port coupled to the radiation area, wherein the radiation area is configured to radiate into space a light signal of a first polarization mode and to receive from the space a light signal containing both the first polarization mode and a second polarization mode, the first and second polarization modes being two perpendicular linear polarization modes including a transverse electric (TE) mode and a transverse magnetic (TM) mode;
an optical lens configured to direct the radiated light signal from the optical transceiver toward a target and to direct a back-reflected light from the target to the optical transceiver, wherein the optical sensor is free of any polarization altering optical component between the optical transceiver and the optical lens; and
a photonic mixer configured to mix the received light signal with a reference local oscillator signal.

2. The optical sensor of claim 1, further comprising:
a laser configured to generate a coherent light signal; and
a power beam splitter configured to direct a portion of the light signal from the laser to the photonic mixer as the local oscillator signal, and to direct another portion of the light signal from the laser to the input port of the optical transceiver;
wherein the input port and the output port of the optical transceiver are two separate ports which are mode matched to respectively pass only the first polarization mode and the second polarization mode, and wherein the optical transceiver is configured to pass the second polarization mode of the received light signal via the output port to the photonic mixer.

3. The optical sensor of claim 1, further comprising:
a laser configured to generate a coherent light signal;
a power beam splitter configured to direct a portion of the light signal from the laser to the photonic mixer as the local oscillator signal; and
a polarization beam splitter and rotator having a first port, a second port, and a third port respectively coupled to the power beam splitter, the photonic mixer, and the optical transceiver,
wherein the power beam splitter is further configured to direct another portion of the light signal from the laser to the first port of the polarization beam splitter and rotator,
wherein the polarization beam splitter and rotator is configured to pass only the first polarization mode of the other portion of the light signal from the first port to the third port,
wherein the input port and the output port of the optical transceiver are a common port coupled to the third port of the polarization beam splitter and rotator and configured passes both the first and the second polarization modes, wherein the optical transceiver is configured to radiate the first polarization mode of the other portion of the light signal from the polarization beam splitter and rotator, and to pass both the first polarization mode and the second polarization mode of the received light signal via the common port to the third port of the polarization beam splitter and rotator, and
wherein the polarization beam splitter and rotator is further configured to convert the second polarization mode of the received light signal from the optical transceiver to the first polarization mode and direct the converted light signal to its second port for coupling to the photonic mixer.

4. An array of optical sensors, comprising:
a plurality of the optical sensors of claim 1;
a laser configured to generate a coherent light signal; and
an optical power splitter and switch tree structure configured to split the coherent light signal of the laser among the plurality of the optical sensors.

5. The array of optical sensors of claim 4, wherein the optical power splitter and switch tree structure includes one or more components selected from a group consisting of: Mach-Zehnder modulators, thermal modulators, and PIN modulators.

6. The array of optical sensors of claim 4, wherein the optical power splitter and switch tree structure is configured to supply light signals to the plurality of the optical sensors simultaneously.

7. The array of optical sensors of claim 4, wherein the optical power splitter and switch tree structure is configured to supply light signals to the plurality of the optical sensors at different times.

8. The array of optical sensors of claim 4, wherein each of the plurality of optical sensors further comprises a power beam splitter configured to direct a portion of the light signal from the optical power splitter and switch tree structure to the photonic mixer as the local oscillator signal, and to direct another portion of the light signal from the optical power splitter and switch tree structure to the input port of the optical transceiver;
wherein the input port and the output port of the optical transceiver are two separate ports which are mode matched to respectively pass only the first polarization mode and the second polarization mode, and wherein the optical transceiver is configured to pass the second polarization mode of the received light signal via the output port to the photonic mixer.

9. The array of optical sensors of claim 4, wherein each of the plurality of optical sensors further comprises:
a power beam splitter configured to direct a portion of the light signal from the optical power splitter and switch tree structure to the photonic mixer as the local oscillator signal; and
a polarization beam splitter and rotator having a first port, a second port, and a third port respectively coupled to the power beam splitter, the photonic mixer, and the optical transceiver,
wherein the power beam splitter is further configured to direct another portion of the light signal from the optical power splitter and switch tree structure to the first port of the polarization beam splitter and rotator,
wherein the polarization beam splitter and rotator is configured to pass only the first polarization mode of the other portion of the light signal from the first port to the third port,
wherein the input port and the output port of the optical transceiver are a common port coupled to the third port of the polarization beam splitter and rotator and configured passes both the first and the second polarization modes, wherein the optical transceiver is configured to radiate the first polarization mode of the other portion of the light signal from the polarization beam splitter and rotator, and to pass both the first polarization mode and the second polarization mode of the received light signal via the common port to the third port of the polarization beam splitter and rotator, and
wherein the polarization beam splitter and rotator is further configured to convert the second polarization mode of the received light signal from the optical transceiver to the first polarization mode and direct the converted light signal to its second port for coupling to the photonic mixer.

10. A method for transmitting an optical signal and detecting a back-reflected optical signal using an optical sensor, comprising:
generating a coherent light signal;
splitting the light signal using a power beam splitter and directing a portion of the light signal to a photonic mixer as a local oscillator signal, and directing another portion of the light signal to an input port of an optical transceiver;
passing only a first polarization mode of the other portion of the light signal through the input port of the optical transceiver to a radiation area of the optical transceiver, and radiating the first polarization mode into space as a radiated light signal;
directing the radiated light signal from the optical transceiver toward a target and directing a back-reflected light from the target to the optical transceiver, without altering polarization modes of the radiated light signal and the back-reflected light signal, wherein the back-reflected light signal contains both the first polarization mode and a second polarization mode, wherein the first and second polarization modes are two perpendicular linear polarization modes including a transverse electric (TE) mode and a transverse magnetic (TM) mode;
capturing the back-reflected light signal by the radiation area of the optical transceiver, including both the first polarization mode and a second polarization mode;
coupling only the second polarization mode of the captured light signal to an output port of the optical transceiver;
directing the light signal from the output port of the optical transceiver into the photonic mixer; and
coherently mixing the local oscillator signal and the received signals from the optical transceiver in the photonic mixer to generate In-phase and Quadrature-phase (IQ) signals.

11. A method for transmitting optical signals and detecting a back-reflected optical signals using a plurality of optical sensors, comprising:
performing the method of claim 10 by each of the plurality of optical sensors,
wherein the step of generating the coherent light signal comprises:
generating a coherent input light using a laser; and
splitting the coherent input light of the laser among the plurality of the optical sensors using an optical power splitter and switch tree structure, to supply the coherent light signals,
wherein coherent light signals are either supplied to the plurality of the optical sensors simultaneously, or supplied to the plurality of the optical sensors at different times.

12. A method for transmitting an optical signal and detecting a back-reflected optical signal using an optical sensor, comprising:
generating a coherent light signal;
splitting the light signal using a power beam splitter and directing a portion of the light signal to a photonic mixer as a local oscillator signal, and directing another portion of the light signal to a first port of a polarization beam splitter and rotator;
the polarization beam splitter and rotator passing only the first polarization mode of the other portion of the light signal from the first port to a third port of the polarization beam splitter and rotator;
an optical transceiver receiving the first polarization mode of the other portion of the light signal from the third port of the polarization beam splitter and rotator, and radiating the first polarization mode into space as a radiated light signal;
directing the radiated light signal from the optical transceiver toward a target and directing a back-reflected light from the target to the optical transceiver, without altering polarization modes of the radiated light signal and the back-reflected light signal, wherein the back-reflected light signal contains both the first polarization mode and a second polarization mode, wherein the first and second polarization modes are two perpendicular linear polarization modes including a transverse electric (TE) mode and a transverse magnetic (TM) mode;
capturing the back-reflected light signal by the radiation area of the optical transceiver, including both the first polarization mode and a second polarization mode;
directing the captured light including both the first and the second polarization modes form the optical transceiver to the third port of the polarization beam splitter and rotator;
the polarization beam splitter and rotator converting the second polarization mode of the received light signal on its third port to the first polarization mode and directing the converted light signal via its second port to the photonic mixer; and
coherently mixing the local oscillator signal and the received signals from the optical transceiver in the photonic mixer to generate In-phase and Quadrature-phase (IQ) signals.

13. A method for transmitting optical signals and detecting a back-reflected optical signals using a plurality of optical sensors, comprising:
performing the method of claim 12 by each of the plurality of optical sensors,
wherein the step of generating the coherent light signal comprises:
generating a coherent input light using a laser; and
splitting the coherent input light of the laser among the plurality of the optical sensors using an optical power splitter and switch tree structure, to supply the coherent light signals,
wherein coherent light signals are either supplied to the plurality of the optical sensors simultaneously, or supplied to the plurality of the optical sensors at different times.
